(19) United States
(12) Patent Application Publication
(10) Pub. No.: US 2020/0353313 A1
(43) Pub. Date: Nov. 12, 2020

(54) PEDAL STRUCTURE FOR EXERCISE BIKE

(71) Applicant: YI-LUN CHEN, TAIPEI CITY (TW)

(72) Inventor: YI-LUN CHEN, TAIPEI CITY (TW)

(21) Appl. No.: 16/861,702

(22) Filed: Apr. 29, 2020

(30) Foreign Application Priority Data
May 6, 2019 (TW) 108115520

(51) Int. Cl. A63B 24/00; B62M 3/08; A63B 22/06; A63B 21/00; A63B 71/06

(52) U.S. Cl. CPC A63B 24/0062; B62M 3/083; B62M 3/086; A63B 22/0605; A63B 2225/50; A63B 71/0622; A63B 2220/833; A63B 2220/36; A63B 21/4034

(57) ABSTRACT

A pedal structure is respectively provided with different coupling structures on two sides of a pedal body to couple and lock the feet of users who wear different types of shoes on the pedal body. One of the sides of the pedal body is provided with a clip coupling structure for coupling and locking a cleat mounted to a bottom of a road bike cycling shoe, and the opposite side of the pedal body is provided with a toe-clip pedal for tying and fixing a regular sports shoe and a skidding prevention structure for preventing skidding relative to the sole of the sports shoe. With such a dual-sided pedal arrangement, the feet of users who wear different types of shoes can be securely held on the pedal body to prevent skidding or idle pedaling during pedaling of the exercise bike to thereby improve accuracy of the training data detected by a training signal detection device.

### BACKGROUND OF THE INVENTION

### 1. Field of the Invention

The present invention relates to a pedal structure for an exercise bike, and in particular to an exercise bike pedal structure that stabilizes measurement of exercising data and is provided for use with cycling shoes of road bikes and regular sports and leisure footwears.

### 2. The Related Arts

Exercise bikes are the one and only choice for sports lovers who wish to fast burn out fat and also to train muscle power. A lot of people enjoy the joy of sweating during cycling and rushing. However, the demand for upgrading of equipment emerges with the continuous increase of skill and training level. Once a certain threshold has been crossed, it would not be sufficient to suit the need of the sports lovers to simply sit and cycle on the same spot.

Taiwan Utility Model Nos. M571338 and M458372 and Taiwan Patent Nos. 1651538 and 1648195 disclosed a power sensor mounted on an exercise bike to supply exercising data to a user using the exercise bike for reference. However, it is common that the user, when pedaling the exercise bike, may unexpectedly move feet or just make idle pedaling, leading to a situation that the exercising data detected is different from actual condition of exercising. To overcome such a problem, manufacturers provide a known clip pedal mounted in an exercise bike to allow a user wearing a road bike cycling shoe to secure the cycling shoe on the clip pedal by means of the cleat on the bottom of the cycling shoe in order to eliminate the situation of undesired feet movement or idle pedaling occurring when the user is pedaling the exercise bike, to thereby improve accuracy of detection or measurement of exercising data.

However, some of the exercise bike users may not own and wish to put on the road bike cycling shoes in cycling an exercise bike and they often wear a regular pair of sports shoes to do training. Thus, an exercise bike with clip pedals mounted thereon only suit the need for a minor population of exercise bike users, and is simply useless for most users wearing regular sports shoes.

In view of the above, the existing exercise bike still suffers a number of drawbacks and the present invention is made to provide a pedal structure for an exercise bike that helps overcome the above issues.

### SUMMARY OF THE INVENTION

To overcome the drawbacks of the prior arts as discussed above, an objective of the present invention is to provide an exercise bike pedal that is effective in fixing both a road bike cycling shoe and a regular sport shoe.

To overcome the above drawbacks, another objective of the present invention is to provide an exercise bike pedal that helps eliminate inaccuracy of detected exercising data due to undesired movement of a shoe stepping on the exercise bike pedal.

To achieve the above objectives, the present invention provides an exercise bike pedal, which mainly comprises a pedal body, a toe-clip pedal, a training signal detection device, a wireless signal transmission unit, and a power supply unit. One side of the pedal body is provided with a clip coupling structure that couples and locks a road bike cycling shoe, and a surface of an opposite side is provided with the skidding prevention structure. The toe-clip pedal is provided on the side of the pedal body that is arranged with the skidding prevention structure at a front edge thereof facing toward a head of the exercise bike. The training signal detection device is mounted on an axle or a metal axle sleeve of the pedal body or is arranged at any location on the pedal body. The wireless signal transmission unit is connected with the training signal detection device. The power supply unit supplies electrical power to the wireless signal transmission unit and the training signal detection device.

In the above structure, the clip coupling structure is a coupling structure that receives a cleat mounted on a bottom of a road bike cycling shoe that is compatible with Shimano-style or Look-style specification.

In the above structure, the skidding prevention structure comprises a planar skidding prevention structure or a perpendicular skidding prevention structure.

In the above structure, the training data detected by the training signal detection device include speed, power, acceleration, force distribution between two feet, calorie, and the pedal body of the training.

In the above structure, the wireless signal transmission unit transmits the training data through Bluetooth, Wi-Fi, ZigBee, Lora (Long Range) IOT or other wireless transmission interface to the receiver-end display.

In the above structure, the receiver-end display comprises one of a personal mobile smart device, a work station, and an exercise bike odometer.

In the above structure, the power supply unit comprises a primary battery or a rechargeable battery.

The exercise bike pedal according to the present invention may be useful with the clip coupling structure for coupling and locking when the user wears a road bike cycling shoe and may also be useful with the skidding prevention structure and the toe-clip pedal for coupling when the user wears a regular sports shoe or even wears no shoe. As such, when the user does training by pedaling an exercise bike, incorrect reading of training result by the user due to an error occurring in training data detected by the training signal detection device resulting from undesired movement of the feet or idle treading during treading down the pedal body can be prevented.

### BRIEF DESCRIPTION OF THE DRAWINGS

FIG. 1 is a perspective view showing an exercise bike pedal structure according to the present invention;

FIG. 2 is an exploded view showing the exercise bike pedal structure according to the present invention;

FIG. 3 is another perspective view showing the exercise bike pedal structure according to the present invention;

FIG. 4 is a perspective view showing the exercise bike pedal structure according to the present invention mounted on a Look-style clip pedal;

FIG. 5 is a block diagram of the exercise bike pedal structure according to the present invention;

FIG. 6 is a state diagram showing a condition of use of the exercise bike pedal structure according to the present invention; and

FIG. 7 is a schematic view showing a known skidding preventing structure of an exercise bike pedal.

### DETAILED DESCRIPTION OF THE PREFERRED EMBODIMENTS

The present invention will be explained below with reference to a detailed description of an embodiment thereof. It is, however, noted that such a description is not intended to limit the scope of protection that the present invention pursues.

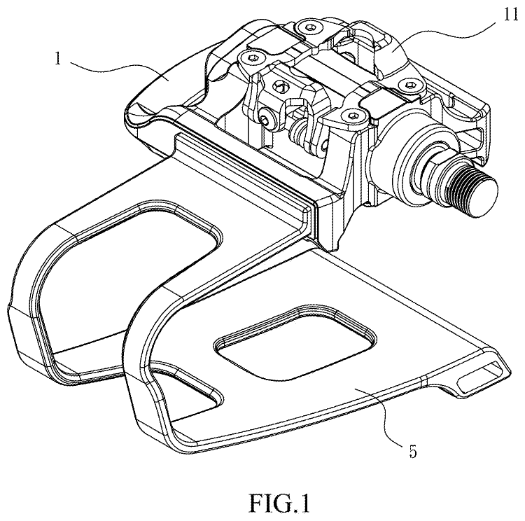

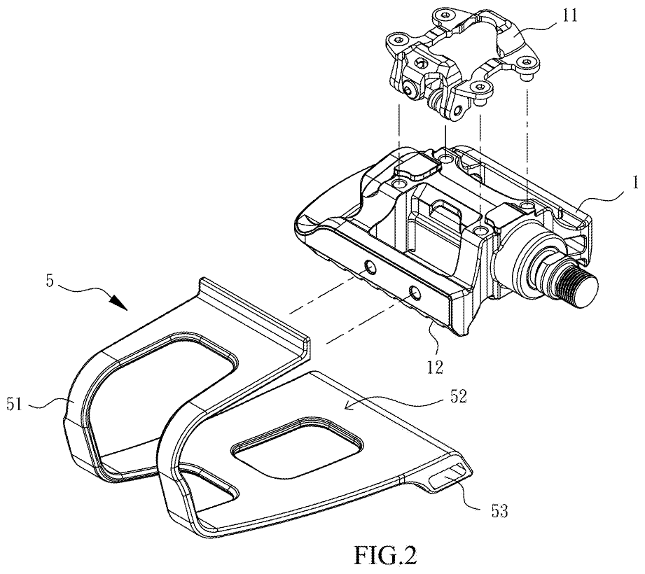

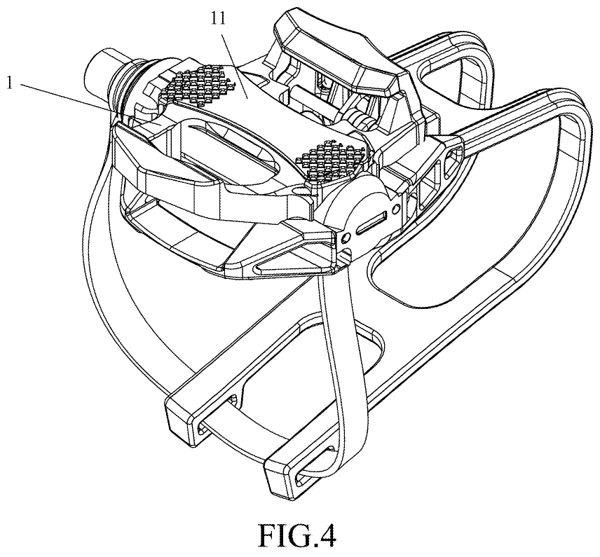

Referring to FIGS. 1-5, the present invention provides an exercise bike pedal, which is a dual-sided pedal including two different arrangements on two sides of a pedal body 1 for use by different users. The present invention is primarily structured such that one side of the pedal body 1 is arranged with a clip coupling structure 11. The clip coupling structure 11 is a clip coupling structure that can be coupled to and locked with a cleat mounted to a bottom of a road bike cycling shoe of which the specification is compatible with the Shimano-style clip pedal (as shown in FIG. 1) or the Look-style clip pedal (as shown in FIG. 4). An opposite side of the pedal body 1 is arranged with a planar or a perpendicular skidding prevention structure 12.

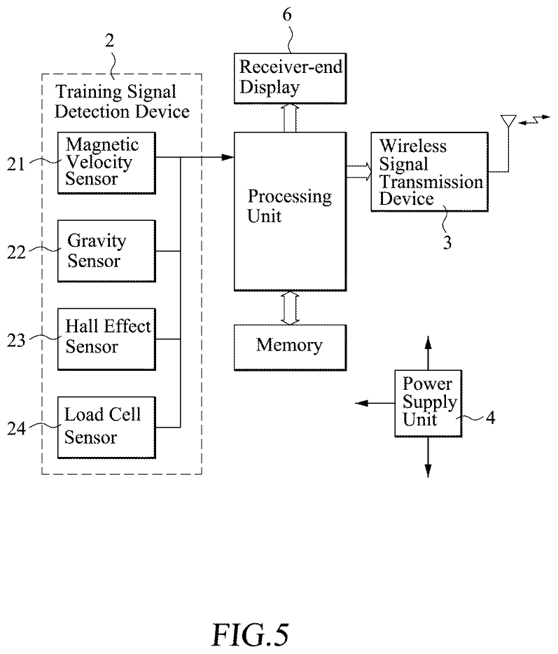

A training signal detection device 2 is arranged on the pedal body 1 at any suitable location or is mounted to an axle or metal axle sleeve of the pedal body 1. As shown in FIG. 5, the training signal detection device 2 comprises a magnetic velocity sensor 21, a gravity sensor 22, a Hall effect sensor 23, and a load cell sensor 24. The training signal detection device 2 is connected with a wireless signal transmission unit 3, and the training signal detection device 2 and the wireless signal transmission unit 3 are supplied with electrical power from a power supply unit 4.

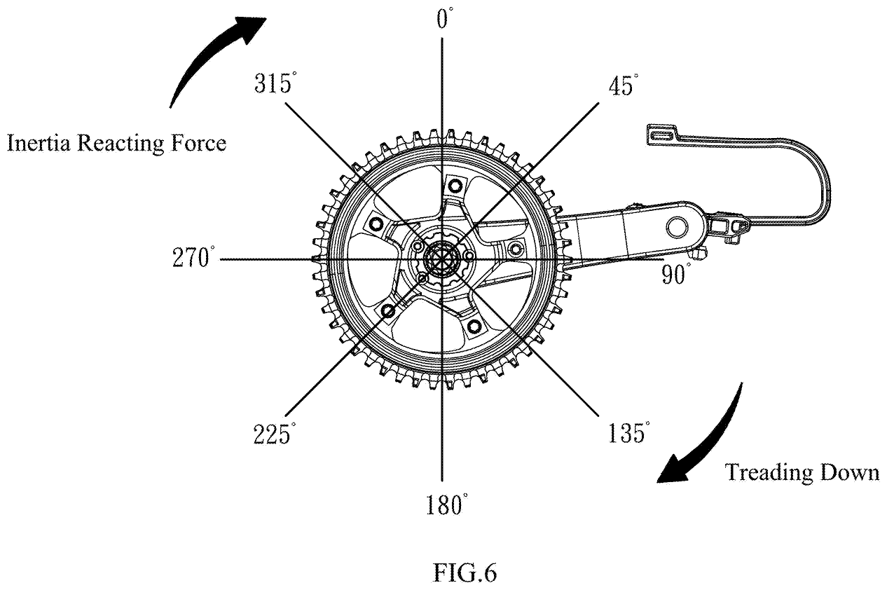

Referring to FIG. 6, when the exercise bike pedal is being treaded down, an inertia reacting force is induced, and as such, the present invention is structured to provide a toe-clip pedal 5 on the side of the pedal body 1 that is arranged with the skidding prevention structure 12 at a front edge thereof in a direction toward a head of the exercise bike, in order to prevent occurrence of the inertia reacting force. The toe-clip pedal 5 has an end connected to the front edge of the pedal body 1 and an opposite end is extended by a distance in the direction toward the head of the exercise bike head and curved upward and in a direction toward the pedal body 1 to form a bow section 51, and thus, the toe-clip pedal 5 is formed with a horizontal opening 52 facing a direction toward the pedal body 1. The toe-clip pedal 5 is provided, at an end thereof that is opposite to the connection thereof with the pedal body 1, with a transverse through hole 53 that is parallel to the pedal body 1 to receive extension of a tie strap (not shown) therethrough.

Since one side of the pedal body is provided with a clip coupling structure 11, when the user wears a road bike cycling shoe, the cleat mounted to the bottom of the cycling shoe can be coupled to the clip coupling structure 11 to secure the cycling shoe on the pedal body 1. When the user pedals the exercise bike, the magnetic velocity sensor 21, the gravity sensor 22, the Hall effect sensor 23, and the load cell sensor 24 of the training signal detection device 2 detect velocity, power, acceleration, and force distribution between the feet, calorie and the number of uses of the pedal body for the training that the user takes in order to provide training data that are then transmitted by a wireless signal transmission device 3 through Bluetooth, Wi-Fi, ZigBee, Lora (Long Range) IOT (Internet of Things), or other wireless transmission interface, to a receiver-end display 6, such as a personal mobile smart device, the work station, and an exercise bike odometer to allow the user to watch the training data.

Further, in case that, instead of a road bike cycling shoe, the user wears a regular sports shoe or even wears no shoe, the pedal body 1 of the exercise bike pedal according to the present invention can be turned over to show the side that is arranged with the skidding prevention structure 12 and a shoe tip of the sports shoe or a tip of a foot of the user is inserted through the opening 52 of the toe-clip pedal 5 to have the shoe sole or the foot sole stepping on the skidding prevention structure 12. Afterwards, the tie strap is used to secure the sports shoe or the foot of the user on the toe-clip pedal 5, so that the sports shoe or the foot of the user can be fixedly held between the toe-clip pedal 5 and the skidding prevention structure 12. When the user pedals the exercise bike, the training signal detection device 2 detects velocity, power, acceleration, and force distribution between the feet, calorie and the number of uses of the pedal body for the training that the user takes in order to provide training data that are then transmitted by a wireless signal transmission device 3 through Bluetooth, Wi-Fi, ZigBee, Lora (Long Range) TOT, or other wireless transmission interface, to a receiver-end display 6, such as a personal mobile smart device, the work station, and an exercise bike odometer to allow the user to watch the training data.

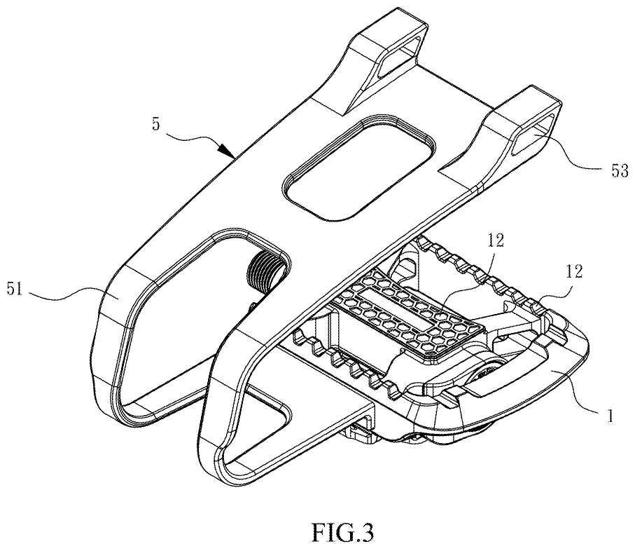

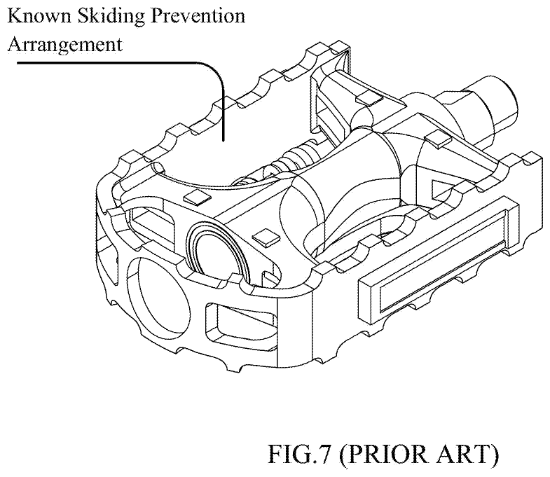

Further, referring to FIG. 7, a known pedal of an exercise bike is provided, circumferentially on an outer rim thereof, with a skidding prevention arrangement in the form of a corrugated structure, which provides only a poor effect of skidding prevention. On the contrary, the kidding prevention structure 12 (as shown in FIG. 3) that is mounted on the pedal body according to the present invention provides a skidding prevention arrangement that is denser than the prior art on the outer rim of the pedal body 1 and also includes a honeycomb skidding prevention arrangement at a central portion of the pedal body 1, so as to increase a contact area thereof with the shoe sole and thus increase friction and enhance the effect of skidding prevention.

Based on the above, the exercise bike pedal according to the present invention may be useful with the clip coupling structure 11 for coupling and locking when the user wears a road bike cycling shoe and may also be useful with the skidding prevention structure 12 and the toe-clip pedal 5 for coupling when the user wears a regular sports shoe or even wears no shoe. Thus, whether the user wears a road bike cycling shoe or a regular sports shoe, the structure according to the present invention is useful to secure and lock it to the pedal body 1, so that when the user does training by pedaling an exercise bike, incorrect reading of training result by the user due to an error occurring in training data detected by the training signal detection device 2 resulting from undesired movement of the feet or idle treading during treading down the pedal body 1 can be prevented.

The above provides a description with reference to an embodiment of the present invention; however, such an embodiment is not provided to unduly constrain the protection scope that the present invention pursues and it is contemplated that equivalent embodiment and variation that are made according the spirit of the present invention fall within the scope of the present invention as defined in the appended claims.

What is claimed is:

1. A pedal structure for an exercise bike, comprising:
a pedal body including a clip coupling structure formed on a first side of the pedal body and a skidding prevention structure formed on a second side opposite to the clip coupling structure;
a training signal detection device arranged on the pedal body, including a magnetic velocity sensor, a gravity sensor, a Hall effect sensor, and a load cell sensor for detection of the pedal body in a riding condition to acquire training data of speed, power, and a number of uses of the pedal body;
a wireless signal transmission unit electrically connected to the training signal detection device to transmit the training data to a receiver-end display;
a power supply unit for supplying an electrical power to the wireless signal transmission unit and the training signal detection device.

2. The pedal structure according to claim 1, further comprising a toe-clip pedal on the second side of the pedal body, formed at a front edge of the pedal body in a direction facing a head of the exercise bike.

3. The pedal structure according to claim 1, wherein the clip coupling structure is a coupling structure that receives a cleat mounted on a bottom of a road bike cycling shoe that is compatible with Shimano-style or Look-style specification.

4. The pedal structure according to claim 1, wherein the skidding prevention structure is selected from one of a planar skidding prevention structure and a perpendicular skidding prevention structure.

5. The pedal structure according to claim 1, wherein the training data detected by the training signal detection device further includes acceleration, force distribution between two feet, and calorie detected during training.

6. The pedal structure according to claim 1, wherein the wireless signal transmission unit transmits the training data through one of Bluetooth, Wi-Fi, ZigBee, and Lora (Long Range) TOT to the receiver-end display.

7. The pedal structure according to claim 1, wherein the receiver-end display includes one of a personal mobile smart device, a work station, and an exercise bike odometer.

8. The pedal structure according to claim 1, wherein the power supply unit is one of a primary battery and a rechargeable battery.

9. The pedal structure according to claim 1, wherein the training signal detection device is mounted on an axle or a metal axle sleeve of the pedal body.
